(19) United States
(12) Patent Application Publication
(10) Pub. No.: US 2014/0369159 A1
(43) Pub. Date: Dec. 18, 2014

(54) MIXING DEVICE FOR MIXING AGGLOMERATING POWDER IN SUSPENSION

(71) Applicants: Stefan Blendinger, Fuerth (DE); Werner Hartmann, Weisendorf (DE)

(72) Inventors: Stefan Blendinger, Fuerth (DE); Werner Hartmann, Weisendorf (DE)

(73) Assignee: SIEMENS AKTIENGESELLSCHAFT, München (DE)

(21) Appl. No.: 14/345,169

(22) PCT Filed: Aug. 16, 2012
(86) PCT No.: PCT/EP2012/065990

§ 371 Date: Mar. 14, 2014

(30) Foreign Application Priority Data
Sep. 16, 2011 (DE) 102011082862.1

(51) Int. Cl. B01F 5/06; B01F 15/02; B01F 3/12

(52) U.S. Cl. CPC B01F 5/0603; B01F 3/12; B01F 15/0202; B01F 2003/125
USPC 366/336

(57) ABSTRACT

A suspension consisting of a carrier fluid and particles suspended in the carrier fluid is mixed by a nozzle generating a suspension jet, a feeding device for introducing powder into the suspension jet, a mixing chamber designed to mix the particles with the powder such that the powder adheres to the particles, and a diffuser stabilizing the suspension such that the particles in the suspension form agglomerates due to the powder.

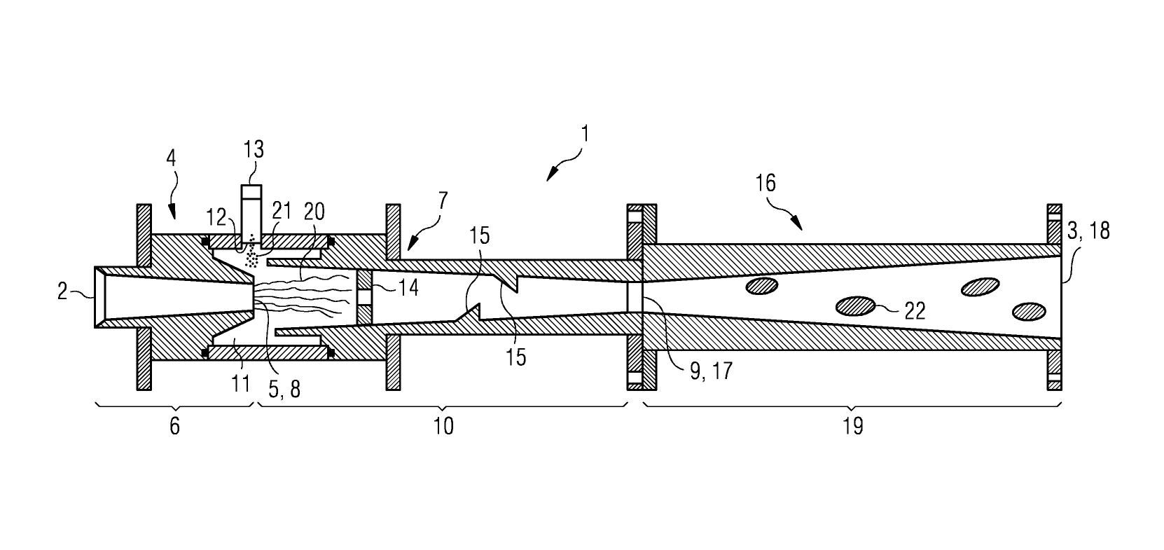

### CROSS REFERENCE TO RELATED APPLICATIONS

This application is the U.S. national stage of International Application No. PCT/EP2012/065990, filed, Aug. 16, 2012 and claims the benefit thereof. The International Application claims the benefits of German Application No. 102011082862.1 filed on Sep. 16, 2011, both applications are incorporated by reference herein in their entirety.

### BACKGROUND

Described below is a mixing device for mixing agglomerating powder in a suspension.

The cultivation of microorganisms on an industrial scale has found many applications in recent years. Thus microorganisms are nurtured in order to produce biomass for obtaining electricity or for production of biodiesel. As part of efforts to reduce global carbon dioxide emissions, photosynthetically-active microorganisms are also being used for fixing carbon dioxide from waste gases.

For the cultivation of microorganisms, such as algae or cyanobacteria for example, both bioreactors and also flat bed systems (aquacultures) are used. The microorganisms are cultivated in a suitable nutrient solution which contains water, a carbon source and also possibly an energy source and supplementary substances such as minerals or trace elements. The composition is governed in such cases by the requirements of the microorganisms.

Since microorganisms only tolerate very low cell densities, large volumes of liquid medium occur during harvesting, from which the microorganisms must be separated in order to process them further. Modern methods use energy-saving magnet separation methods for this purpose, in which the microorganisms are loaded with magnetite particles and are subsequently conveyed through a magnetic field. In such cases the magnetized microorganisms are separated from the non-magnetized liquid. A magnet separation method is described for example in DE 10 2009 030 712.

In order to arrive at an efficient separation by magnetite particles, the particles must bind to the microorganisms in a stable manner. An intensive contact between the microorganisms and the magnetite particles is required for this purpose, which leads to a stable adhesion of the magnetite particles to the microorganisms and a formation of agglomerates. In a known method, the contact between the microorganisms and the magnetite particles is established by stirring the magnetite particles into a microorganisms-nutrient suspension. The disadvantage here however is that the energy of the agitation energy is only introduced into the suspension unevenly. This means that overall more energy is necessary for agitation than would be necessary were the agitation energy able to be introduced evenly into the suspension in order to achieve a sufficiently intensive contact between the magnetite particles and the microorganisms.

### SUMMARY

The mixing device described below mixes agglomerating powder in a suspension, wherein mixing energy is able to be introduced evenly into the suspension during mixing and through this method a good agglomerate formation is obtained.

The mixing device for mixing agglomerating powder into a suspension formed by a carrier fluid and particles suspended therein has a nozzle for creating a suspension jet, a feed device for introducing the powder into the suspension jet, a mixing chamber which is configured for mixing the particles with the powder, so that the powder adheres to the particles and a diffuser for stabilizing the suspension such that the particles to which the power attaches form agglomerates in the suspension.

The powder may be a magnetite powder, the particles may be algae and/or cyanobacteria and the carrier fluid may be a nutrient solution for the algae and/or cyanobacteria.

The nozzle, the mixing chamber and the diffuser may be connected in series. The nozzle, the mixing chamber and the diffuser may be combined to form a tube. The feed device may open out with its feed opening into the mixing chamber, so that on entry of the suspension jet into the mixing chamber the powder is able to be introduced from the feed device through the feed opening into the suspension jet. The feed opening of the feed device may be disposed outside the suspension jet in the mixing chamber.

The mixing chamber may be configured to swirl the suspension jet with the powder. For this purpose the mixing chamber may have an aperture and/or a deflection profile, with which the swirling of the suspension jet with the powder is able to be brought about. In addition the diffuser may have a degree of opening and a length so that the suspension is able to be stabilized in the diffuser without producing any separation, through which the agglomerates form in the suspension.

The mixing device makes an even introduction of the mixing energy into the suspension possible during mixing of the powder into the suspension, through which intensive contact between the powder and the particles is achieved. This enables the particles, because of the agglomeration effect of the powder, to effectively form the agglomerates. The mixing device functions especially advantageously if the suspension is formed from microorganisms and water and also if the powder is magnetite powder. The suspension with the microorganisms is pumped into the mixing device as a propellant, wherein the suspension is accelerated in the nozzle, through this a propulsion jet is formed by the nozzle, into which the magnetite powder is mixed either in the gas phase or in the liquid phase. In the mixing chamber the microorganisms and the magnet particles are homogenously mixed by high shearing forces and turbulences. In the diffuser disposed downstream of the mixing chamber the speed of the suspension is partly converted into pressure. In the diffuser the shear forces and turbulences reduce and the desired formation of microorganisms-magnetite agglomerates can result in the diffuser.

The tubular arrangement of the nozzle, the mixing chamber and the diffuser also creates a quasi-multistage embodiment of the mixing device, wherein the mixing device is able to have a continuous suspension flow passing through it. Thus with the mixing device the magnetite powder is mixed into the microorganism suspension in a continuous process, through which the formation of agglomerates is promoted. The embodiment of the mixing device, e.g., with the aperture and the deflection profile, makes possible a good mixing of the microorganism suspension and the magnetite particles. The energy is introduced evenly into the suspension here, whereby the necessary energy for achieving a predetermined degree of mixing of the suspension is minimized. Thus, by comparison with conventional mixing devices in which the introduction of the energy into the suspension is uneven, energy can be advantageously saved. It is also advantageous, when the mixing device is employed in a system for creating microorganisms, for the suspension with its agglomerates embodied therein to be able to be produced continuously.

### BRIEF DESCRIPTION OF THE DRAWINGS

These and other aspects and advantages will become more apparent and more readily appreciated from the following description of the exemplary embodiment, taken in conjunction with the accompanying schematic drawing of which:

The FIGURE is a longitudinal section of an embodiment of the mixing device.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

As can be seen from the FIGURE, a mixing device 1 is embodied elongated and in a tubular shape, wherein the mixing device 1 seen in the FIGURE has an inlet cross-section 2 on the left and an outlet cross-section 3 on the right. For mixing a suspension the suspension is to be conveyed through the inlet cross-section 2 into the mixing device 1, with a pump for example. At the inlet cross-section 2 the mixing device 1 has a nozzle 4, the inlet of which coincides with the inlet cross-section 2. In the flow direction the flow cross-section of the nozzle 4 narrows up to its nozzle outlet cross-section 5, wherein the flow of the suspension is accelerated as it passes through the nozzle 4. Thus the length of the nozzle 4 is an acceleration path 6 which is selected to be long enough for a jet of the suspension to be formed at the nozzle outlet cross-section 5.

Downstream of the nozzle 4 the mixing device 1 has a mixing chamber 7 which is embodied in a tubular shape and has a mixing chamber inlet cross-section 8 which coincides with the nozzle outlet cross-section 5, and a mixing chamber outlet cross-section 9. Between the mixing chamber inlet cross-section 8 and the mixing chamber outlet cross-section 9 a mixing path 10 extends, which is selected long enough for a good mixing of the suspension in the mixing chamber 7 to be able to be brought about.

A swirling chamber 11 of the mixing chamber 7 is embodied at the mixing chamber inlet 8, wherein the swirling chamber 11 has a larger cross-section than the mixing chamber inlet cross-section 8. Through this the suspension jet 20 entering through the nozzle outlet cross-section 5 and the mixing chamber inlet cross-section 8 is embodied in the swirling chamber 11 as a free fluid jet.

Attached to the swirling chamber 11 is a feed opening 12, to which in its turn a feed line 13 is fastened, through which a powder 21 is able to be conveyed into the swirling chamber 11. The powder 21 is magnetite powder and is able to be conveyed with any conceivable conveying device into the swirling chamber 11 via the feed opening 12. In the swirling chamber 11 particles of the powder 21 get into the edge areas of the suspension jet 20 and are carried along by the jet. The result is an even distribution of the powder 21 in the suspension jet 20.

Downstream of the feed opening 12 the mixing chamber 7 has an aperture 14, through which the suspension flows under strong swirling. The mixing chamber 7 also has deflection profiles 15 downstream of the aperture 14, which are disposed raised on the inner wall of the mixing chamber 7 and thereby lead to a further swirling of the suspension flow. The mixing chamber 7 is also conceivable without the aperture 14 and/or the deflection profiles 15.

Because the swirling chamber 11 has a larger cross-section than the mixing chamber inlet cross-section 8, the area outside the mixing chamber cross-section 8 lies in its wind shadow. In this area the powder 21 that is carried along by the suspension jet 20 is introduced through the feed opening 12. The subsequent flow through the aperture 14 and passing the deflection profiles 15 leads to an additional mixing-in of the suspension flow in the mixing chamber 7 such that an even more intensive contact between the microorganisms and the magnetite powder is achieved. The result is that an adhesion of the magnetite powder to the microorganisms takes place in the mixing chamber 7, through which the microorganisms for their part tend to form agglomerates 22. The deposition of the magnetite powder 21 on the microorganisms enables the microorganisms to magnetically attract each other via the magnetite powder. The local accumulation of microorganisms caused thereby leads to the formation of the agglomerates 22.

A diffuser 16 is disposed downstream of mixing chamber 7 at the mixing chamber outlet cross-section 9, of which the diffuser inlet cross-section 17 coincides with the mixing chamber outlet cross-section 9. The diffuser 16 extends in the flow direction up to its diffuser outlet cross-section 18 while overcoming a stabilization path 19, wherein the diffuser 16 expands in its cross-section over the stabilization path 19. The degree of opening of the diffuser 16 and the length of the stabilization path 19 are selected so that the suspension flow in the diffuser 16 is stabilized such that the formation of the agglomerate 22 takes place to a sufficient extent. At the diffuser outlet cross-section 18, which coincides with the outlet cross-section 3 of the mixing device 1, the suspension with the agglomerates 22 flows out.

The nozzle 4, the mixing chamber 7 and the diffuser 16 are arranged in series behind one another, wherein the suspension flows in a straight line through the nozzle 4, the mixing chamber 7 and the diffuser 16. Thus the mixing device 1 is embodied in the shape of a tube, wherein it is conceivable for the nozzle 4 the mixing chamber 7 and the diffuser 16 to be joined to one another in one piece. At the inlet cross-section 2 of the mixing device 1 the suspension flows with more or less finely distributed microorganisms into the mixing device 1 and at the outlet cross-section 3 the suspension flows out with agglomerated microorganisms.

Harvesting of the microorganisms from the suspension is able to be carried out especially advantageously with a magnetic separation method. The fact that the microorganisms are present as the agglomerates 22 and in addition are also magnetic means that the microorganisms in their agglomerates 22 are able to be separated from the suspension simply and effectively with a magnet. It is conceivable for the mixing device 1 to be built into a feed unit of a magnetic separation device. In this case the suspension can be fed via the mixing device 1 to the magnetic separation device, wherein the agglomerates 22 can be obtained from the suspension with a high yield and low energy outlay. The use of the mixing device 21 also makes possible a continuous supply of the suspension to the magnetic separation device, so that the magnetic separation device is likewise able to be operated continuously.

The fact that the mixing device with the nozzle 4, the mixing chamber 7 and the diffuser 16 is embodied as a quasi-multistage device means that a good mixing of the suspension takes place in the mixing device 1, through which the magnetite powder has an intensive contact with the microorganisms. The energy introduced during mixing into the suspension is even, which makes a higher level of mixing of the suspension with a low energy use possible. On operation of the mixing device 1 the pump for conveying the suspension to the inlet cross-section 2 of the mixing device 1 is provided as the only energy consumer. Any stirring devices which are known in systems for mixing a suspension with a powder and which consume energy do not have to be provided with the mixing device 1. Large speed gradients in the suspension flow obtain in the mixing chamber 7, which means that the suspension is strongly swirled and turbulent. Thus high shear forces obtain in the suspension in the mixing chamber 7, which support the intensive contact between the magnetite powder and the microorganisms.

Via the feed opening 12 the mass flow is able to be dispensed to the powder 21 which is introduced into the mixing chamber 7. The powder mass flow is able to be adjusted to the proportion of microorganisms in the suspension, so that as much powder 21 as possible can adhere to the microorganisms and as little powder 21 as possible flows along ineffectively in the suspension. This makes it possible, with a possible fluctuation of the concentration of microorganisms in the suspension, for the powder mass flow to be adjusted accordingly.

In an especially advantageous version magnetite or a comparable material is used, of which the surface is functionalized chemically such that the magnetite particles enter into an especially intensive binding with the cell surfaces of the algae or the microorganisms.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-8. (canceled)

9. A mixing device for mixing agglomerating powder into a suspension formed by a carrier fluid and particles suspended therein, comprising:
a nozzle creating a suspension jet;
a feed device introducing the agglomerating powder into the suspension stream;
a mixing chamber, configured to mix the particles with the agglomerating powder so that the agglomerating powder adheres to the particles, having an aperture and/or a deflection profile in an area in which the cross-section narrows in the direction of flow, causing a swirling of the suspension jet with the agglomerating powder; and
a diffuser stabilizing the suspension such that the particles to which the agglomerating powder attaches form agglomerates in the suspension.

10. The mixing device as claimed in claim 9, wherein the agglomerating powder is magnetite powder.

11. The mixing device as claimed in claim 10, wherein the particles are algae and/or cyanobacteria and the carrier fluid is a nutrient solution for the algae and/or the cyanobacteria.

12. The mixing device as claimed in claim 11, wherein the nozzle, the mixing chamber and the diffuser are connected in series.

13. The mixing device as claimed in claim 12, wherein the nozzle, the mixing chamber and the diffuser are formed in a tube.

14. The mixing device as claimed in claim 13, wherein the feed device opens out in a feed opening into the mixing chamber, so that, on entry of the suspension jet into the mixing chamber, the agglomerating powder is able to be introduced by the feed device through the feed opening into the suspension jet.

15. The mixing device as claimed in claim 14, wherein the feed opening of the feed device is disposed outside the suspension jet in the mixing chamber.

16. The mixing device as claimed in claim 15, wherein the diffuser has a degree of opening and a length such that the suspension is stabilized without separation in the diffuser, through which the agglomerates form in the suspension.
